(19) United States
(12) Patent Application Publication
(10) Pub. No.: US 2009/0044016 A1
(43) Pub. Date: Feb. 12, 2009

(54) PROTECTING A DSP ALGORITHM

(75) Inventor: Marc Vauclair, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,427

(22) PCT Filed: Nov. 4, 2005
(86) PCT No.: PCT/IB05/53605

§ 371 Date: May 2, 2007

(30) Foreign Application Priority Data
Nov. 9, 2004 (EP) 04105615.1

(51) Int. Cl. H04L 9/06

(52) U.S. Cl. 713/176

(57) ABSTRACT

A software implementation of a digital signal processing function is protected by selecting a subset of parameters (210) of the signal processing function and embedding a watermark (230) in the selected parameters.

### FIELD OF THE INVENTION

The invention relates to a method of protecting a software implementation of a digital signal processing function. The invention further relates to a computer program product for causing a processor to execute a digital signal processing function and to a processor for executing such software.

### BACKGROUND OF THE INVENTION

Many functions of devices, such as consumer electronics devices like a televisions, set-top boxes, recording devices, MP3 players, etc., and computer devices, are performed by a processor loaded with a program that performs specific signal processing functions. The processor is typically a digital signal processor (DSP) but may also be a micro-controller, such as an ARM processor, or a general purpose processor, such as used in PCs. The signal processing functions include filtering, encoding/decoding, compressing/decompressing, etc. Determining and implementing these functions requires a significant effort and highly trained people. It is therefore desired to protect such an effort. Copyright protection of a software implementation of these functions only has a limited effect. Frequently in actual systems only parts of a library with signal processing functions are used and combined with application specific software. This makes it difficult to establish that a core aspect of a function has been copied.

It is known to watermark an entire software module, e.g. using a digital signature. Such a technique however does not provide protection against a person ‘copying’ a specific function, like a filter, from the module. Such copying may be possible when the source code is made available for use under specific licensing conditions or has been obtained through reverse engineering.

### SUMMARY OF THE INVENTION

It is an object of the invention to provide a method of protecting know-how embodied in a software implementation of a signal processing function. It is a further object to provide protected software embodying a signal processing function and a processor with such software.

To meet an object of the invention, a method of protecting a software implementation of a digital signal processing function includes: selecting a subset of parameters used by the signal processing function and/or used for designing the signal processing function; and embedding a watermark in the selected parameters.

The inventor had the insight that parameters of the signal processing function can be watermarked. Typically parameters of the signal processing function are stored using memory locations with more bits than minimally required for adequate performance of the algorithm. This gives room for disturbing such a parameter with a watermark. The watermarked parameter may be a parameter actually used by the signal processing function. The watermarked parameter may also be a design parameters of the signal processing function, i.e. a parameter that affects the design of the function. In this case, the design parameter is preferably also present in the actual signal processing function (making infringement detection simple). Alternatively, the design parameter has influenced one or more other parameters that are present in the actual signal processing function.

Watermarking the parameters enables detection of copying even if not the entire software module is taken over. It also enables detection if part of the actual code is re-programmed but the parameters have been copied. Preferably parameters are selected that represent unique know-how (i.e. those that are not yet publicly known).

According to the measure of the dependent claim 2, the selected parameter is a parameter used by signal processing function and the step of selecting a subset of parameters includes selecting parameters that can be disturbed without substantially affecting a quality of the signal processing function. The method further includes selecting a number of least significant bits of the selected parameters that can be disturbed without substantially affecting a quality of the signal-processing function; and embedding the watermark in the selected least significant bits of the selected parameters.

Typically parameters of the signal processing function are stored using memory locations with more bits than minimally required for adequate performance of the algorithm. Frequently a number of quantization bits (i.e. the least significant bits) of those parameters can be changed without affecting the perceived behavior of the signal processing function. One or more of such parameters are then selected and a watermark is embedded in some (or all) of the bit locations that can be changed. This enables detection of re-use of those parameters by a third party. The watermark may be fixed and may be combined in any suitable way with the selected least significant bits of the selected parameters (e.g. through a bit-wise XOR operation). Embedding the watermark in this way is a simple way of protecting the parameters without affecting the quality of the signal processing function. The embedding may take place based on the programming code of the signal processing function, i.e. after the function has been fully designed.

According to the measure of the dependent claim 3, the method includes designing the signal processing function in dependence on the selected parameters with embedded watermark. In this embodiment, first the watermark is embedded and then the function is designed (e.g. optimized) for the parameter with embedded watermark. In this way, the newly designed function can compensate for the disturbance that occurred due to the watermark. This may result in maintaining a higher quality of the function and/or allows more bits to be used for the watermark since the effect of the watermark is (partly) compensated by the re-design. It should also be noted that in this approach it is more difficult to remove the watermark. In the embodiment of claim 2 the watermark can be removed by simply removing the involved least significant bits (e.g. truncating the parameter). In the embodiment of claim 3 typically more bits can be used for the watermark and fully removing the watermark by truncating would thus affect the quality.

The selected parameter is preferably also present in the function itself (i.e. the parameter is a parameter being used by the function). If so, detection of infringement is straightforward. If so desired, the parameter may be a design parameter that determines/influences other parameters that are used by the function. Embedding a watermark in this latter category of parameters will still influence the other parameters by the watermark may not be explicitly in those parameters. Proving infringement is thus more difficult.

According to the measure of the dependent claim 4, the watermark is determined dynamically based on the selected parameters. It will be appreciated that all or only a selection of those bits may be used as input to the algorithm that generates the watermark. Any suitable watermarking technique may be used. A dynamically determined watermarks is more difficult to break and, if broken, will only affect program parts with exactly the same parameters.

According to the measure of the dependent claim 5, a digital signature is calculated over the selected parameters. The signature replaces a selection of the bits of the selected parameters. This is a simple and reliable technique.

According to the measure of the dependent claim 6, the signature is calculated over all bits of the parameters. In this way a sufficient entropy can be achieved to obtain a reliable watermark.

According to the measure of the dependent claim 7, embedding the watermark includes replacing the selected least significant bits of the selected parameters by respective bits of the generated signature. This is a simple way of embedding a watermark.

According to the measure of the dependent claim 8, non-selected bits of the selected parameters are kept unmodified. In this way it is easier to detect the actual parameter that was modified using the watermark. This is particularly useful if a third party has significantly changed the structure of an illegally copied program, possibly in order to hide such copying, and may have also changed some least significant bits (but not all).

Dependent claim 9 describes parameters that are good candidates for being watermarked.

According to the measure of the dependent claim 10, a boundary point for a function approximation is changed. Frequently functions are numerically approximated by splitting the entire interval into sub-intervals and use a good approximation per sub-interval. A certain tolerance exists in choosing boundary points where the interval is split into sub-intervals. This is thus a good candidate for being changed using the watermark.

These and other aspects of the invention are apparent from and will be elucidated with reference to the embodiments described hereinafter.

### BRIEF DESCRIPTION OF THE DRAWINGS

In the drawings:

FIGS. 1A and B show block diagrams of a system in which the invention may be employed;

FIGS. 2A and B shows flow diagrams of the method according to the invention;

FIG. 3 shows a further embodiment of the method;

FIG. 4 illustrates forming a block a bits for determining the watermark; and

FIG. 5 shows function approximation.

### DETAILED DESCRIPTION OF THE PREFERRED EMBODIMENT

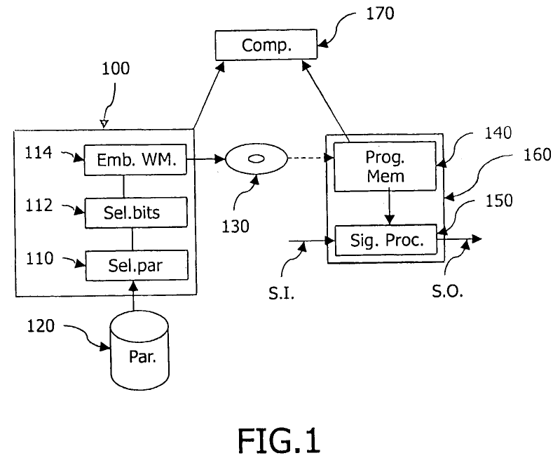

FIGS. 1A and 1B show a block diagram of a system in which the invention may be employed. The system includes a device 160 that processes a digital signal. The signal is preferably a signal with technical character, such as an audio signal (including speech), a video signal (including graphics) and other signals representing a physical quantity, such as pressure, temperature, current, voltage, etc. The device 160 processes such signal using a processor 150. The processor 150 may be of any suitable type, such as a digital signal processor (DSP) optimized for processing streams of signals, but may also be a microcontroller, such as an ARM processor, or a general purpose processor, such as used in PCs. The signal processing functions performed by the processor 150 may include but are not limited to filtering, encoding/decoding, compressing/decompressing, etc. The device 160 further includes a program memory 140 storing instructions of the program executed by the processor 150. Any suitable program memory may be used, including ROM, RAM, flash, etc. The program memory 140 may be separate from the processor 150 or be embedded into it. The device 160 may be any device performing a signal processing function including, but not limited to, a consumer electronics device or personal computer processing audio and/or video or a device controlling an industrial process, such as a chemical process.

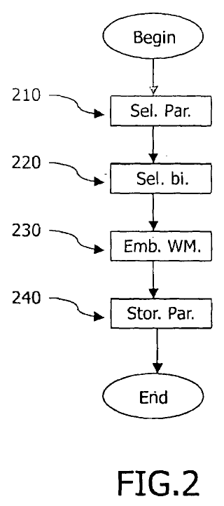

The system further includes a device 100 that performs the method according to the invention. The method will be described in more detail below with reference to FIGS. 2A and 2B. The device 100 is able to generate a signal processing function, typically in the form of software, where a watermark has been embedded in parameters of the signal processing function. To this end, the device 100 includes means 110 for selecting a subset of parameters of the signal processing function and means 114 for embedding the watermark in the selected parameters. The invention may be used in two ways, depending on whether the embedding of the watermark occurs after designing the function or before designing the function. FIGS. 1A and 2A show the situation where the watermark is added after designing the signal processing function. In this context with ‘after designing the function’ is meant that the function is already fully designed (i.e. predetermined with respect to this invention) or, if not, any modifications to the function do not affect the selected parameters (i.e. the function is predetermined with respect to the selected parameters but may still be re-designed/modified with respect to other parameters).

The device 100 may be implemented in any suitable way. Preferably, device 100 is implemented on a computer, such as a workstation or personal computer, where a processor performs the described functions under control of a suitable program. The processor loaded with the program may thus perform any or all the functionality of the means 110, 112, and 114. The parameters may be retrieved from a storage 120, such as a hard disk. The parameters may be stored separately, for example by a person who designed the signal processing function, or may be embedded in the signal processing function. In the latter case, means 110 and/or 112 have to retrieve the parameters from the functions. Preferably, the designer of the functions has provided information to enable such retrieval (e.g. in the form of addressing information identifying suitable parameters). The signal processing function with embedded watermark may be supplied in any suitable way, e.g. on a storage medium 130 or though Internet, to enable it to be stored in the program memory 140 (e.g. by the manufacturer of device 160).

Among others, suitable parameters for embedding a watermark in are parameters that represent
a coefficient of a digital signal filter;
a threshold;
a cost in it cost function;
a coefficient of a function approximation, or
a control point of an approximation of a digital graphic.
   Persons skilled in the art can easily select other suitable parameters in the digital signal processing function.

The system also includes a device 170 for checking whether the device 160 uses a signal processing function with embedded watermark. This checking may be done in any suitable form. For example, a straightforward comparison can be made between the parameters in the program memory 140 of an actual device using the function and those generated by device 100.

In the first embodiment of FIGS. 1A and 2A, the parameters are already present in a form as they were intended to be used during the design of the signal processing function. Possibly not all of those parameters are suitable for being watermarked. To this end, means 110 selects those parameters that can be disturbed without substantially affecting a quality of the signal processing function. In practice, a human designer of the system may have compiled a list of parameters that may be modified. Suitable candidate parameters are those with at least one least significant bit being irrelevant for the performance of the function. The device 100 also includes means 112 for selecting a number of least significant bits of the selected parameters that can be disturbed without substantially affecting a quality of the signal processing function. Similar to as indicated above, the human designer may have indicated for each parameter the minimum number of most significant bits that may not be affected by the watermark. The means 112 may then be supplied with the number of bits available in the target platform for storing the parameter (e.g. 32 or 64 bits) and can based on this information select the number of least significant bits that are available for that target platform. In practice, DSPs/microcontrollers are available for various widths of the parameters. Some processors even support various formats. Typical formats are 16, 20, 24 or 32 bits for a fixed point parameter and 32, 64 or 80 for a floating point parameter.

The device 100 uses the means 114 for embedding the watermark in the selected least significant bits of the selected parameters.

FIG. 2A shows details of the first embodiment of the method of protecting the software implementation of a digital signal processing function according to the invention. The method includes the steps of selecting 210 a subset of parameters of the signal processing function that can be disturbed without substantially affecting a quality of the signal processing function. As described above, a pre-selection of suitable parameters may already have been done by the designer of the functions. In such a case, the selection step may be simply involve taking all of those or making a further selection within the pre-selection. The selected parameters are those parameters can be changed to a certain degree without affecting the perceived behavior of the signal processing function (e.g. some least significant bits fall below the quantization level. In step 220, a number of least significant bits of the selected parameters are selected that can be disturbed without substantially affecting a quality of the signal processing function (this also includes the situation where the effect is compensable). Preferably, in a situation where n bits are going to be ‘watermarked’ the selected bits are the n-least significant bits. However also a choice of least significant bits may be made and the choice can be seen as part of the watermark. For example, if m bits may be changed without affecting the quality (m>n) then n out of these m bits may be chosen pseudo-randomly, e.g. under control of a key. The number of bits that can be disturbed may be determined in any suitable way, for example by simulation, theoretical analysis, etc. . . .

In step 230, a watermark is embedded in the selected least significant bits of the selected parameters. The watermark may be a fixed, predetermined watermark. As will be described in more detail below, it may also be created dynamically. The watermark may be embedded in any suitable way. For example, the watermark may be combined with the selected least significant bits of the selected parameters through a bit-wise XOR operation. The watermark may also simply replace those bits (overwriting). An alternative way would be to encrypt the selected least significant bits of the selected parameters under control of a key, where the watermark could be the key. In an embodiment not all bits that could be modified are actually modified; one or more of those bits are maintained in an unmodified form. This enables the device 170 to easier locate the parameters in 160 in the case that they have been mixed/shuffled in that device to make it more difficult to identify illegal use of the software. If some of the bits are unmodified the device 170 can search based on those bits. An additional advantage is that in a juridical procedure evidence may be considered to be stronger.

In the second embodiment of FIGS. 1B and 2B, the means 110 are used to select parameters that are used for designing the signal processing function and are suitable for being watermarked. As before, a human designer may have compiled a list of candidates from which the selection is made. Since the parameters are selected before the design of tile function, selection of the number of bits that may be used is in general less critical. The means for selecting the bits are still shown using number 112. As for the previous embodiment, the means 114 are used for embedding the watermark in the selected parameters. The parameters may be the same as described before the previous embodiment. However, also parameters may be used that are only used during the design and on which parameters used by the function are based. For example, if a low-pass digital filter with a cut-off frequency of 12 KHz. has to be designed (i.e. the input design parameter is 12 KHz.) this design parameter may be water-marked (for example resulting in a watermarked parameter with a value of 12.1987654 KHz., where 0.1987654 is the watermark. This design parameter is in itself not a parameter (i.e. the actual filter coefficients) present in the actually designed filter. However, it is possible to take the actual filter coefficients and compute numerically from those coefficients the cut-off frequency of the filter. This will recover a large part of the 0.1987654 watermark enabling detection of the copying.

The second embodiment is thus particularly intended for the situation where embedding of the watermark in the parameter might influence the performance of the signal processing function (i.e. above the quantization level) but this can be compensated for (e.g. by adjusting the function through another parameter). An example of this latter case will be described in more detail below for function approximation. Thus the main difference between the two embodiments is that for the first embodiment the signal processing function is not optimized for the embedded watermark (and thus the embedding can take place after the function has been designed), whereas for the second embodiment the signal processing function is not optimized for the embedded watermark (and thus the embedding takes place before the function has been designed). Therefore, for FIG. 1B the means 116 for designing the function are shown and in FIG. 2B the step 250 of designing the function has been shown. In the approach of the second embodiment the watermark is added before or during the design, preferably by the design tool. In this way, many bits (typically all bits) of the designed (computed) parameters are influenced by the watermarking process. There is thus no easy way to alter them while preserving the quality (simply truncating will not fully remove the watermark).

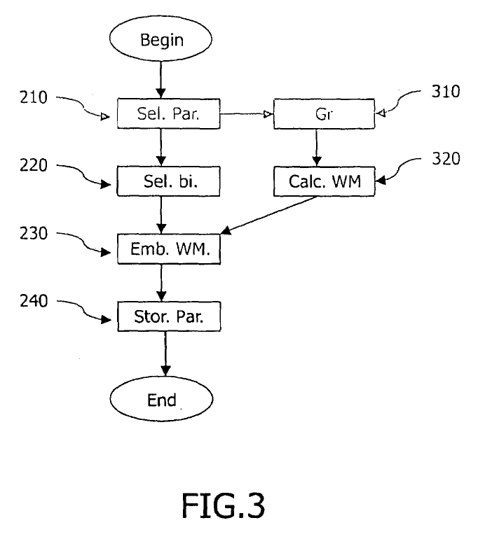

In a preferred embodiment of the method (applicable to both embodiments described above), the watermark is determined in step 320 of FIG. 3 dynamically in dependence on the selected parameters. Many types of dependencies may be used. For example, the watermark may depend on all bits of all selected parameters, the watermark may depend only on the selected bits of the selected parameters, the watermark may depend only on the non-selected bits of the selected parameters, etc. Each approach has its own advantages. For example, using all bits increases the entropy. Using the non-selected bits has the advantage that the watermark only depends on bits that are unchanged and thus are highly visible. This may help in proving that those parameters where watermarked. Using the selected bits has the advantage that also in situations where those bits are simply overwritten by the watermark, those bits actually contributed to the watermark. Preferably, the watermark is calculated dynamically in step 320 using cryptographic techniques. Any suitable technique may be used.

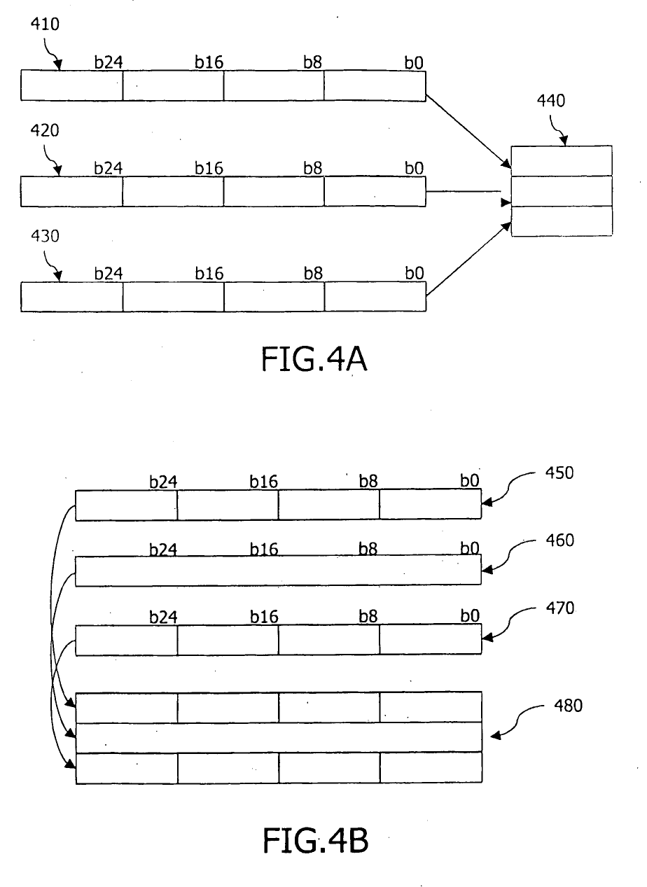

FIG. 3 also illustrates a further embodiment, first a block of bits is formed in step 310. This block of bits includes at least one bit of each selected parameter. The calculation of the watermark as shown in step 320 is then done by calculating a digital signature of the formed block under control of a predetermined key. FIG. 4A shows that of the exemplary parameter 410, 420 and 430 the respective 8 least significant bits (LSB) numbered b0 to b7 are used to form a block 440 of 24 bits. As described above, the block 440 may equally well be formed of other selected bits. Using sequential bits of a parameter makes forming of the block straightforward. However, if so desired also other selections may be made, such as a pseudo-random selection under control of a key. FIG. 4B shows a further embodiment, wherein the block 440 includes substantially all bits of the selected parameters 410, 420, 430.

Next an example is given where a watermark is embedded in 25 32-bit floating point parameters. The parameters are shown as five groups (filt1, filt2 SECTION 1, filt 2 SECTION 2, filt 3 SECTION 1, filt 3 SECTION 2) each with five parameters (A0, A1, A2, B1, B2). In this example the parameters have the values:

| static BIQUAD_Coefs filt1 [ 1 * 5 ] = | |
|---|---|
| { 8.93973493820715E−0001f, | /* A0 */ |
| −1.78794698764143E+0000f, | /* A1 */ |
| 8.93973493820715E−0001f, | /* A2 */ |
| −1.78791066853493E+0000f, | /* B1 */ |
| 8.87983306747928E−0001f | /* B2 */}; |

static BIQUAD_Coefs filt2 [ 2 * 5 ] =
{/* * SECTION 1 for Floating Point 32-bit IIR library “SS” */

| | |
|---|---|
| 3.08440265117571E−0008f, | /* A0 */ |
| 2.16880542388767E−0008f, | /* A1 */ |
| 3.08440266659157E−0008f, | /* A2 */ |
| −1.85565557939837E+0000f, | /* B1 */ |
| 8.56229364078828E−0001f, | /* B2 */ |

/* * SECTION 2 for Floating Point 32-bit IIR library “SS” */

| | |
|---|---|
| 1.00000000000000E+0000f, | /* A0 */ |
| 2.99999994169253E+0000f, | /* A1 */ |
| 7.99999992604188E−0001f, | /* A2 */ |
| −1.88105292049614E+0000f, | /* B1 */ |
| 8.81634156692019E−0001f | /* B2 */ }; |

static BIQUAD_Coefs filt3 [ 2 * 5 ] =
{ /* * SECTION 1 for Floating Point 32-bit IIR library “SS” */

| | |
|---|---|
| 3.78857742794282E−0005f, | /* A0 */ |
| 4.57715485588563E−0005f, | /* A1 */ |
| 3.78857742794282E−0005f, | /* A2 */ |
| −1.89193814821509E+0000f, | /* B1 */ |
| 8.92366735223261E−0001f, | /* B2 */ |

/* * SECTION 2 for Floating Point 32-bit IIR library “SS” */

| | |
|---|---|
| 1.00000000000000E+0000f, | /* A0 */ |
| −4.00000000000000E+0000f, | /* A1 */ |
| 1.00000000000000E+0000f, | /* A2 */ |
| −2.99581991517854E+0000f, | /* B1 */ |
| 8.95940882922500E−0001f /* B2 */ }; | |

In a hexadecimal representation the 32 bits contain the following values (shown per group):
0×3f64db72 0×bfe4db72 0×3f64db72 0×bfe4da42 0×3f6352e0
0×3304795e 0×32ba4c89 0×3304795e 0×bfed861f 0×3f5b31d9
0×3f800000 0×40400000 0×3f4ccccd 0×bff0c658 0×3f61b2c7
0×381ee78a 0×383ffad3 0×381ee78a 0×bff22b07 0×3f647225
0×3f800000 0×c0800000 0×3f80000 0×c03fbb83 0×3f655c62
   In this example, in principle the 8 least significant bits of each parameter may be replaced, maintaining the 24 most significant bits. The watermark is calculated by generating a digital signature using a HMAC (keyed message authentication code) operating on the 25 parameter block. For the HMAC the SHA-1 hash function was used. As a key PHILIPSPDSLLEUVENRIŜÂB̂ĈD̂ÊF̂ĜH was used, where ̂A stands for CTRL-A (ASCII code 01), ̂B stands for CTR-L-B (ASCII code 02), . . . This function delivers a 160 bits signature. In this example, the signature is inserted in (divided over) the 8 least significant bits of the first 20 parameters. The last five parameters are unaltered. It will be noted that they have participated to the signature computation. This gives the following modified coefficients:
0×3f64db3c 0×bfe4dbb5 0×3f64dbf8 0×bfe4daf2 0×3f6352df
0×33047965 0×32ba4c1f 0×330479bb 0×bfed868a 0×3f5b319e
0×3f80002e 0×4040008a 0×3f4ccc34 0×bff0c61d 0×3f61b2d6
0×381ee7ce 0×383ffa39 0×381ee73b 0×bff22b43 0×3f647208
0×3f800000 0×c0800000 0×3f800000 0×c03fbb83 0×3f655c62

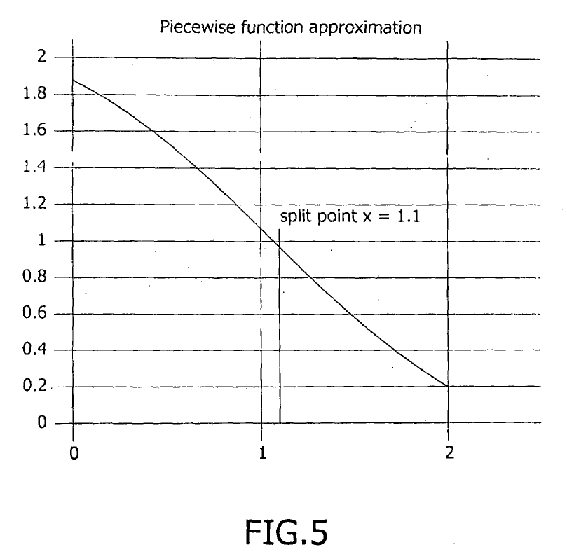

In an embodiment according to the invention, the signal processing function is approximated per subinterval of an interval and the parameters considered for this embodiment are the coefficient of the boundary points for the successive subintervals. This is based on the fact that a function can be numerically approximated in several ways. One of the techniques used to improve the performances and the quality of the approximation of a function on an interval is to split the interval in several pieces (sequential sub-intervals) and to find the best approximation of the function on each of those sub-intervals. Such an approach will be referred to as piece-wise approximation. The “split points” form the boundary points of the subintervals. The way the interval is split is in general not critical: variations on the boundaries can have a small influence on the quality of the approximation. Thanks to this tolerance for the variations, it is possible to embed a watermark, such as a cryptographically secure signature, in the least significant bits of the value of the coordinates of the split points. This embodiment is illustrated in FIG. 5 using an example with a piecewise approximation of the function y=f(x)=I+cos(0.5*x) on the interval [0 . . . 2] with a split point in x=1.1. FIG. 5 shows the situation where the two pieces are approximated by second order polynomials (i.e. parabolas), giving the following piecewise approximation of the function y=f(x):

y=1.88634 −0.573305*x −0.24336*x² for xε[0 . . . 1.1]

y=2.43188 −1.57329*x +0.227149*x² for xε]1.1 . . . 2]

and x=1.1 is the split point.

This gives the following maximum for the absolute error between the approximation and the function approximated:

max ε_{left}=0.00956336

max ε_{right}=0.00530383

Moving the split point from 1.1 to 1.2 while keeping the same approximation, i.e. using:

y=1.88634 −0.573305*x −0.24336*x² for xε[0 . . . 1.2]

y=2.43188 −1.57329*x +0.227149*x² for xε]1.2 . . . 2]

gives the following error values:

max ε_{left}=0.0232218

max ε_{right}=0.00497099.

Moving the split point from 1.1 to 1.0 in a similar way gives the following error values:

max ε_{left}=0.00875632

max ε_{right}=0.0149952.

As can be seen from this example, shifting the boundary any where between 1.0 and 1.2 will give a maximum increase of the approximation error of 0.024. If this does not substantially affect the quality of the approximation thus a major change in the parameter is possible. Using a 32 bits floating point representation for the split point x-coordinate (8 bits for the exponent and 24 bits for the mantissa) gives the following hex-coded values:

1.0: 0×3f800000

1.1:0×3f8ccccd

1.2: 0×3f99999a

This means that 21 bits of the mantissa can be replaced by a cryptographically secure signature without substantially altering the quality of the approximation. It will be appreciated that the amount of bits that can be considered as ‘least significant’, in the sense that they may be changed, is large if the sensitivity to the position of the split points is low.

In an example that follows the approach of the second embodiment, the fact that the boundary will be shifted is taken into account and compensated for. The function approximation is preferably optimized such that the change in position of the split points within large intervals minimizes the impact of these variations on the overall precision. This is illustrated in the following example where the additional information is used that the interval on which one wants the split point to be moved. The left part of the curve is approximated using a polynomial that takes into account the values of the function to approximate on [0 . . . 1.2] while the right part is approximated on [1.0. . . 2]. This gives an overlap between the approximations on the interval [1.0. . . 1.2].

This gives the following new piecewise approximation:

y=1.88926 −0.593899*x −0.22093*x² for xε[0. . . 1.1]

y=2.37313 −1.49926*x +0.204311*x² for xε]1.1 . . . 2]

with the following error characteristics:

max ε_{left}=0.011674

max ε_{right}=0.00699143.

Move the split point to 1.2 gives:

max ε_{left}=0.0127175

max ε_{right}=0.00699143.

Moving the split point to 1.1 gives:

max ε_{left}=0.011674

max ε_{right}=0.00745122.

The pre-conditioning of the approximation gives a resulting approximation with an error threshold of 0.013 instead of 0.024.

Persons skilled in the art will easily recognize that the method described above does not alter the runtime behavior of the processing module in terms of execution cycles and storage requirements.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating, several means, several of these means may be embodied by one and the same item of hardware. The mere fact that certain measures are recited in mutually different dependent claims does not indicate that a combination of these measures cannot be used to advantage.

1. A method of protecting a software implementation of a digital signal processing function; the method including:
selecting a subset of parameters (210) used by the signal processing function and/or used for designing the signal processing function;
and
embedding a watermark (230) in the selected parameters.

2. The method as claimed in claim 1, wherein the selected parameter is a parameter used by signal processing function and the step of selecting a subset of parameters includes selecting parameters (210) that can be disturbed without substantially affecting a quality of the signal processing function;
the method further including selecting a number of least significant bits (220) of the selected parameters that can be disturbed without substantially affecting a quality of the signal processing function; and
embedding the watermark (230) in the selected least significant bits of the selected parameters.

3. The method as claimed in claim 1, wherein the method includes designing the signal processing function in dependence on the selected parameters with embedded watermark.

4. The method as claimed in claim 1, including determining the watermark in dependence on the selected parameters.

5. The method as claimed in claim 4, including forming a block of bits including at least one bit of each selected parameters; generating the watermark by calculating a digital signature of the formed block under control of a predetermined key.

6. A method as claimed in claim 5, wherein the block includes substantially all bits of the selected parameters.

7. A method as claimed in claim 2, wherein embedding the watermark includes replacing the selected least significant bits of the selected parameters by respective bits of the generated signature.

8. A method as claimed in claim 2, wherein non-selected bits of the selected parameters are maintained in an unmodified form.

9. A method as claimed in claim 1, wherein the selected parameter represents one of the following:
a coefficient of a digital signal filter;
a threshold;
a cost in a cost function;
a coefficient of a function approximation, or
a control point of an approximation of a digital graphic.

10. A method as claimed in claim 8, wherein the function is approximated per subinterval of an interval and the coefficient of the function approximation represents a boundary point of successive subintervals.

11. A processor (150) including a memory (140) storing a program for causing the processor to execute a digital signal processing function where at least one parameter of the signal processing function embeds a watermark.

12. A computer program product for causing a processor to execute a digital signal processing function where at least one parameter of the signal processing function embeds a watermark.
